(19) United States
(12) Patent Application Publication
(10) Pub. No.: US 2009/0012855 A1
(43) Pub. Date: Jan. 8, 2009

(54) SYSTEM AND METHOD OF USING CAPTCHAS AS ADS

(75) Inventors: Naveen Jamal, San Jose, CA (US); Chris Kalaboukis, Los Gatos, CA (US); Naveen Agarwal, Fremont, CA (US); Clarence Chung, Saratoga, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/774,382

(22) Filed: Jul. 6, 2007

(51) Int. Cl. G06Q 30/00

(52) U.S. Cl. 705/14

(57) ABSTRACT

A method of using advertisements in a Completely Automatic Public Turing test to tell Computers and Humans Apart (CAPTCHA) challenge/response transaction. In accordance with one aspect, a server allows access to some resource if the response to the ad/CAPTCHA challenge is an acceptable response.

### BACKGROUND OF THE INVENTION

1. Field of the Invention

Aspects of the present invention relate generally to the use of CAPTCHAs as a means to ensure that the user of a web service is human, and more specifically to a system and method of using advertisements both alongside CAPTCHAs and as the CAPTCHAs themselves.

2. Description of Related Art

A CAPTCHA, an acronym which stands for Completely Automatic Public Turing test to tell Computers and Humans Apart, is a mechanism commonly used during account and content creation to ensure that the user is not automated software pretending to be a human. For example, a CAPTCHA may be employed when one desires to create a new web-based e-mail account or when one seeks to leave a comment on a web page; it acts as an added layer of security to ward off “robots” looking to generate e-mail SPAM, link SPAM on a weblog or forum, or any of a host of other nefarious goals.

Employing conventional methodologies, CAPTCHAs are implemented in a variety of ways, each with its own strengths and weaknesses. One of the more common ones is the character-based CAPTCHA. This implementation usually presents the user with a random string of characters “hidden” within a graphic image. These characters may be distorted (e.g., twisted to varying degrees, stretched, etc.) and/or layered beneath image artifacts so as to disguise their true value and confuse automated attempts to “read” them. The human user is then required to deduce from the jumbled image, the string of characters, and reproduce them, in order, before the system will let the user progress further.

In addition to character-based CAPTCHAs, there are also audio CAPTCHAs, which speak a phrase (e.g., a simple sentence, a sequence of numbers, etc.) and ask the user to reproduce it. There also is an image-based CAPTCHA, usually requiring the user to answer a simple question about the image (e.g., is this a tiger or a lion?, what color is the girl's hat?, how many gorillas are in the image?, etc.). Still another CAPTCHA asks the user to solve a simple mathematical formula (e.g., 80+6=?).

Each of these methods is susceptible to automated circumvention, and none takes advantage of using advertising either together with the CAPTCHA or as the CAPTCHA itself. It would be desirable to use advertisements together with the CAPTCHA. It also would be desirable to make CAPTCHAs more secure.

### SUMMARY

In light of the foregoing, it is a general object of the present invention to use advertisements to augment the presentation of CAPTCHAs so as to further ingrain the advertised brand into the user's mind and, concurrently, to provide a new source of revenue for the service provider.

It is another object of the invention to make CAPTCHAs more secure by asking the user to realize a concept around the proposed image(s), instead of asking them to simply state what the image(s) is or is not.

### BRIEF DESCRIPTION OF THE DRAWING FIGURES

FIG. 1A is an example of the current text-based CAPTCHA model.

FIG. 1B is an example of an advertisement augmenting a CAPTCHA.

FIG. 1C is an example of using an advertisement as a CAPTCHA.

FIG. 1D is an example of using product placement as a CAPTCHA.

### DETAILED DESCRIPTION

Aspects of the present invention are described below in the context of employing advertisements in CAPTCHAs through various methods. These methods may include the augmentation of a CAPTCHA to include an advertisement or the use of an advertisement or product in lieu of the usual CAPTCHA.

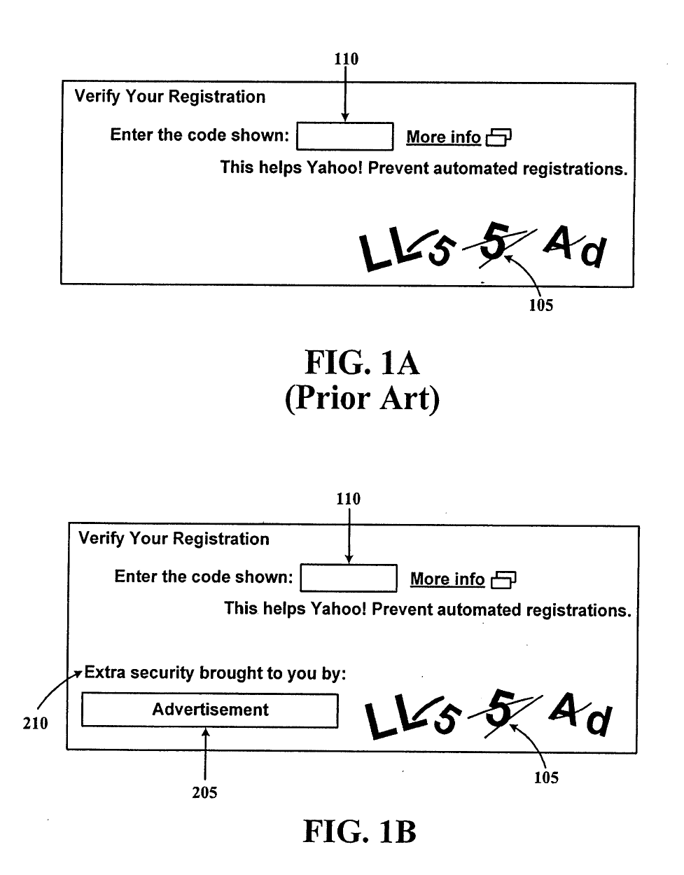

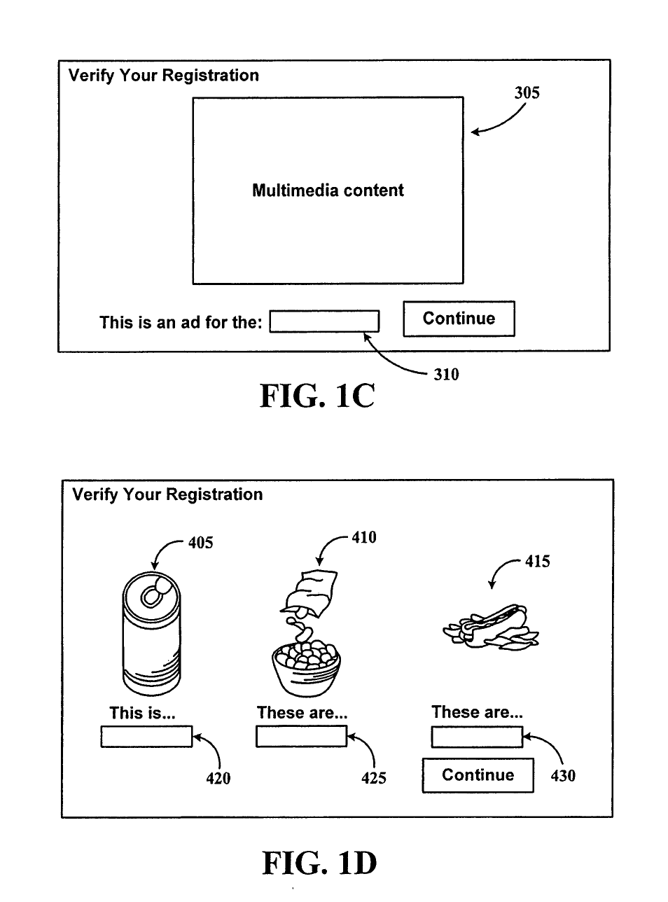

FIG. 1A illustrates the current character-based CAPTCHA process as it may be used on a registration page for some service. As can be seen in FIG. 1A, the CAPTCHA 105 is a character-based graphic image consisting of the following random sequence of characters and numbers: “LL55Ad”. The CAPTCHA 105 is both warped and somewhat obstructed by artifacts in the image. To complete a valid registration, a human user must respond to the CAPTCHA challenge 110; i.e., relay the sequence of characters in the CAPTCHA 105. If the information entered matches the stored value of the CAPTCHA 105, the user will be deemed human and allowed to complete the registration.

In one embodiment, the current CAPTCHA process may be augmented to allow the display of advertisements alongside the CAPTCHA. For example, in FIG. 1B, as in FIG. 1A, there exists both a CAPTCHA 105 and a CAPTCHA challenge 110. However, FIG. 1B also contains an advertisement 205. Though FIG. 1B shows the advertisement 205 to the left of the CAPTCHA 105, it can be placed anywhere near the CAPTCHA 105 so as to intimate some relationship between the CAPTCHA and the ad. Such “sponsorship” of the ad may be implied through the ad's proximity to the CAPTCHA, or may be made explicit through language similar to that found at 210.

In another embodiment, the advertisement itself can be the CAPTCHA. For example, in FIG. 1C, the system contains a CAPTCHA/Ad 305 and a CAPTCHA challenge 310. Here, instead of the usual character-based CAPTCHA, the advertisement is the CAPTCHA. The CAPTCHA/Ad 305 can be any multimedia content, such as, for example, a graphic image, an audio sequence, a video, a Flash animation/video, or any combination thereof. For example, in the case of a single graphic image, the user may be required to answer the question, “This is an ad for the: ?”. If the user responds with the make and/or model of the car, the user will be allowed to proceed.

Similarly, a video advertisement may be played and the user asked the same question (i.e., “This is an ad for the: ?”). As another example, the CAPTCHA/Ad may be an advertisement for a car, and the digital instrument panel of the car shows its speed as it accelerates. The user could then be asked, for example, “What was the car's fastest speed?” Other displays, such as a radio tuner display, also could be a source of a question (e.g. “What station is displayed on the radio?”) Not only do such examples permit an entirely new revenue stream (i.e., by serving ads where they previously were not being served), but they would also further ensure that the entity attempting to get around the CAPTCHA was in fact human.

In still another embodiment, the CAPTCHA can be replaced with a graphic image representing the product or service; these graphic images do not necessarily have to be created for the sole purpose of using them as an advertisement (i.e., they can simply be everyday images of the product/service). In FIG. 1D, there are shown three images, one of cola 405, one of chips 410, and one of hot dogs 415. While generic versions of these products are shown for purposes of this disclosure, it will be appreciated that they can each be replaced with a particular brand's product. Each of these images requires an answer from the user as to what the image is, the CAPTCHA challenges 420, 425, and 430. The images can be produced in any order and in any quantity. For example, if increased security is required, the operators of the CAPTCHA may choose to include three or more images, but if less security is needed, two images or just one image may be sufficient. Further, one brand can be used for all the images (i.e., a single brand could “buy” all of the images needed for the particular multi-image CAPTCHA) or different brands can be used for each image in a multi-image CAPTCHA.

By requiring the user to enter information about the image (or multiple images as the case may be), various goals are met: (1) the product is further imprinted into the mind of the user; (2) the person providing the CAPTCHAs gains a new revenue stream; and (3) the CAPTCHA is more effective at weeding out automated attempts to circumvent the system due to the questions being asked of the user.

Unlike character-based CAPTCHAs, there exists the possibility that a CAPTCHA/Ad may have multiple correct answers. For example, a user looking at CAPTCHA 405 in FIG. 1D, may respond to the CAPTCHA challenge 420 with “soda,” “pop,” etc., or any of the various names by which that particular brand of soda is known. The system may account for multiple plausible variations by making all of them valid answers to the CAPTCHA 405. While it may be the case that a user sometimes does not come up with a valid answer on the first try, the second or third try is more likely to be successful (as is sometimes the case with current CAPTCHA implementations).

Though it is possible to allow for multiple correct answers to the CAPTCHA/Ad, an advertiser may wish to limit this number to one, namely the trademarked name or something similar, as this would further imprint the brand into the user's mind. For example, CAPTCHA 405 in FIG. 1D, may accept as the only valid answer the trade name of the soda shown, and completely disregard other, more generic descriptions of the product (e.g., “soda” or “pop”). These decisions may be made on an advertiser-by-advertiser basis.

In each of the embodiments described herein, there should be some way for the system to choose which advertisement(s) to use as a CAPTCHA or to place next to a CAPTCHA. While the CAPTCHA/Ads could be pulled at random, it is likely that some advertisers may desire, or require, the ads to be somewhat relevant to whatever it is the user is attempting to do, access, retrieve, etc. Moreover, the ads will likely be more effective if used in this manner.

In light of this, context-specific ads may be used in much the same way as they are already used in other aspects of web activity. This may be accomplished by relying on a contextual pointer, which may in turn be based on the context/content of the current page, the context/content of the previous page(s), the context/content of the service to be provided by the page requiring a CAPTCHA in the first place, or any combination thereof. This is similar to how targeted ads are already delivered, for example, in search results or inline with a web page.

Finally, advertisers may also desire to choose to have their advertisements used only in/as CAPTCHAs on web sites or pages directed toward certain market segments or demographics. For example, an automobile company may prefer to have its advertisements used in/as CAPTCHAs only on car-centric sites. As another example, a shoe company may wish for its latest shoe ad to be used in/as a CAPTCHA only on teen-heavy social-networking sites. Such functionality may be realized in a variety of ways, such as, for example, checking the address of the website against a list, supplied by the advertiser, of “allowable” sites; if the website is in the advertiser's list, the CAPTCHA/Ad may be displayed on that particular site.

While the above CAPTCHA/Ad embodiments work by asking the user about a single image, video, etc., or multiple, serialized images, videos, etc., the system may also provide CAPTCHAs based around a “concept”—something that does not necessarily exist in the image itself, but is evoked by the image—where the CAPTCHAs may or may not be revenue-based (i.e., contain advertisements). The conceptual CAPTCHA is rooted in the desire for added security, and may be implemented in a variety of ways.

One embodiment may involve the use of multiple images and ask the user to state what the images have in common or in what kind of situation they may be used together, etc. As an example, in FIG. 1D there is a picture of a can of soda 405, a bag of chips 410, and a package of hot dogs 415. The question asked the user may be, “Where might you find these items used together?” The response to such a question is inherently open-ended, and so multiple answers may be allowed, such as, for example, “picnic,” “baseball game,” etc. Similarly, the user might be asked to pick out the item that does not belong in the set of images. For example, if an image of a blow dryer were used at 415 instead of an image of hot dogs, the question might be, “Which of these items does not belong at a picnic?”

It will be appreciated that the same example conceptual CAPTCHA could be implemented with “ads” by showing images of the particular products in their recognizable trade dress. As before, these ads may be designed specifically for the CAPTCHA or may simply be everyday images of the products. In either case, the ultimate goal of the CAPTCHA—to differentiate humans from robots—is furthered, as it would currently be very difficult for any automated system to defeat such a scheme.

Another embodiment may require only a single image, video, etc. For example, a user may be presented with an image of Santa Claus, fireworks, a jack o'lantern, a menorah, or the like, and asked, “With which holiday is this image most associated?” If desired, these “concepts” could be tailored to most anything; e.g., a country, a culture, a demographic, etc.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of using advertisements in a Completely Automatic Public Turing test to tell Computers and Humans Apart (CAPTCHA) challenge/response transaction; said method comprising:
displaying an advertisement;
issuing a CAPTCHA challenge related to said advertisement; and
allowing access to a resource if a response to said CAPTCHA challenge is satisfactory.

2. The method of claim 1 further comprising retrieving said advertisement from a pool of advertisements.

3. The method of claim 2 wherein said retrieving is informed by a contextual pointer.

4. The method of claim 3 wherein said contextual pointer is related to content displayed concomitant with said CAPTCHA and said CAPTCHA challenge.

5. The method of claim 3 wherein said contextual pointer is related to content to be displayed concomitant with said resource.

6. The method of claim 1 wherein said advertisement comprises multimedia content.

7. The method of claim 1 wherein said displaying further comprises displaying a plurality of advertisements.

8. The method of claim 7 wherein said issuing further comprises issuing a plurality of CAPTCHA challenges, each related to a distinct advertisement.

9. The method of claim 7 wherein said issuing comprises issuing a CAPTCHA challenge related to said advertisements.

10. A method of implementing a Completely Automatic Public Turing test to tell Computers and Humans Apart (CAPTCHA) challenge/response transaction; said method comprising;
displaying a CAPTCHA comprising multimedia content depicting an item or concept;
issuing a CAPTCHA challenge related to said item or concept; and
allowing access to a resource if a response to said CAPTCHA challenge is satisfactory.

11. The method of claim 10 further comprising retrieving said CAPTCHA from a pool of CAPTCHAs.

12. The method of claim 11 wherein said retrieving is informed by a contextual pointer.

13. The method of claim 12 wherein said contextual pointer is related to content displayed concomitant with said CAPTCHA and said CAPTCHA challenge.

14. The method of claim 12 wherein said contextual pointer is related to content to be displayed concomitant with said resource.

15. The method of claim 10 wherein said CAPTCHA comprises an advertisement.

16. The method of claim 10 wherein said CAPTCHA comprises a plurality of distinct multimedia content.

17. The method of claim 16 wherein said CAPTCHA challenge comprises an inquiry into a relation between or among said plurality of distinct multimedia content.

18. The method of claim 15 wherein said CAPTCHA challenge comprises a challenge to identify said advertisement.

19. The method of claim 15 wherein said displaying further comprises displaying a plurality of advertisements.

20. The method of claim 19 wherein said issuing further comprises issuing a plurality of CAPTCHA challenges, each related to a distinct advertisement.

21. The method of claim 19 wherein said issuing comprises issuing a CAPTCHA challenge related to said advertisements.
